(19) United States
(12) Patent Application Publication
(10) Pub. No.: US 2021/0239853 A1
(43) Pub. Date: Aug. 5, 2021

(54) SYSTEM AND METHOD FOR VEHICLE PATH ESTIMATION USING VEHICULAR COMMUNICATION

(71) Applicant: Honda Motor Co., Ltd., Tokyo (JP)

(72) Inventors: Samir K. AL-STOUHI, Dearborn, MI (US); Paritosh KELKAR, Dearborn, MI (US); Hasan TAFISH, Farmington Hills, MI (US)

(21) Appl. No.: 17/214,088

(22) Filed: Mar. 26, 2021

Related U.S. Application Data
(63) Continuation of application No. 15/851,536, filed on Dec. 21, 2017.

(51) Int. Cl. G01S 19/46; H04W 4/46

(52) U.S. Cl. CPC G01S 19/46; H04W 4/46

(57) ABSTRACT

A computer-implemented method and system for vehicle path estimation using a vehicular communication network. The method includes receiving a first set of position measurements of a first remote vehicle and a second set of position measurements of the first remote vehicle from messages transmitted using the vehicular communication network. The method includes determining a path shape of an initial path estimate of the first remote vehicle. The initial path estimate is based on the first set of position measurements. The method includes determining a corrected vehicle path estimate of the first remote vehicle by fitting the second set of position measurements to the path shape of the initial path estimate.

This application is a continuation of U.S. application Ser. No. 15/851,536 filed on Dec. 21, 2017, which is expressly incorporated herein by reference.

### BACKGROUND

Vehicle navigation systems can use different independent position measurements (e.g., satellite based measurements, on-board sensor measurements) for vehicle path estimation and localization. Using mobile communication networks (e.g., vehicle communication networks), vehicle navigation systems can acquire these positions measurements from various sources connected to the vehicle communication network. Satellite based measurements (e.g., GPS) and dead-reckoning based measurements are useful for vehicle localization, however, in some scenarios these measurements are not accurate, particularly when communicated over a vehicle communication network. For example, GPS measurements about a first vehicle received over a vehicle communication network and GPS measurements about a second vehicle received over a vehicle communication network can have an error of about 1.5 meters. Position estimates can be improved using vision based measurements, however, the accuracy of vision sensors can degrade with distance. Accordingly, fusion of different types of position measurements using the vehicle communication network can help improve vehicle path estimation and localization.

### BRIEF DESCRIPTION

According to one aspect, a computer-implemented method for vehicle path estimation using a vehicular communication network includes, receiving a first set of position measurements related to a position of a first remote vehicle, and a second set of position measurements related to the position of the first remote vehicle from messages transmitted using the vehicular communication network. The method includes determining a path shape of an initial path estimate of the first remote vehicle. The initial path estimate is based on the first set of position measurements. Further, the method includes determining a corrected vehicle path estimate of the first remote vehicle by fitting the second set of position measurements to the path shape of the initial path estimate.

According to another aspect, a system for vehicle path estimation using a vehicular communication network includes a plurality of remote vehicles configured for computer communication using the vehicular communication network, and a processor operably connected for computer communication with the plurality of remote vehicles. The processor is configured to receive a first set of position measurements about a first remote vehicle and a second set of position measurements about the first remote vehicle using the vehicular communication network. The processor is configured to determine a path shape of an initial path estimate of the first remote vehicle. The initial path estimate is based on the first set of position measurements. The processor is configured to determine a corrected vehicle path estimate of the first remote vehicle by fitting the second set of position measurements to the path shape of the initial path estimate.

According to a further embodiment, a non-transitory computer-readable storage medium including instructions that when executed by a processor, causes the processor to, establish an operable connection for computer communication between a first vehicle and one remote vehicles using a vehicular communication network. Further, the processor receives a first set of position measurements about a position of the first remote vehicle and a second set of position measurements about the position the first remote vehicle from messages transmitted using the vehicular communication network. The processor determines a path shape of an initial path estimate of the first remote vehicle. The initial path estimate is based on the first set of position measurements. The processor also determines a corrected vehicle path estimate of the first remote vehicle by translating the path shape of the initial path estimate to minimize a distance between the first set of position measurements and the second set of position measurements.

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIG. 1A is a schematic view of an exemplary traffic scenario implementing vehicle path estimation using a vehicle communication network according to an exemplary embodiment;

FIG. 1B is a schematic diagram of a vehicle communication network for implementing vehicle path estimation according to an exemplary embodiment;

FIG. 2 is a process flow diagram of a method for vehicle path estimation using a vehicle communication network according to an exemplary embodiment;

FIG. 3A is a schematic diagram of exemplary position measurements and initial path estimation using GPS and dead-reckoning data according to an exemplary embodiment;

FIG. 3B is a schematic diagram of the exemplary position measurements of the initial path estimation of FIG. 3A, but also including vision based position measurements according to an exemplary embodiment;

FIG. 3C is a schematic diagram of the exemplary position measurements of the initial path estimation of FIGS. 3A and 3B, but also including translation of a shape path of the initial path estimation according to an exemplary embodiment;

FIG. 4 is a process flow diagram of a detailed method for the vehicle path estimation of FIG. 2 including determining a corrected vehicle path estimate according to an exemplary embodiment; and

FIG. 5 is a schematic diagram of position estimate data clusters and centroids with translation of the path shape according to the centroids according to an exemplary embodiment.

### DETAILED DESCRIPTION

The following includes definitions of selected terms employed herein. The definitions include various examples and/or forms of components that fall within the scope of a term and that can be used for implementation. The examples are not intended to be limiting. Further, the components discussed herein, can be combined, omitted or organized with other components or into organized into different architectures.

“Bus,” as used herein, refers to an interconnected architecture that is operably connected to other computer components inside a computer or between computers. The bus can transfer data between the computer components. The bus can be a memory bus, a memory processor, a peripheral bus, an external bus, a crossbar switch, and/or a local bus, among others. The bus can also be a vehicle bus that interconnects components inside a vehicle using protocols such as Media Oriented Systems Transport (MOST), Processor Area network (CAN), Local Interconnect network (LIN), among others.

“Component”, as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) can reside within a process and/or thread. A computer component can be localized on one computer and/or can be distributed between multiple computers.

“Computer communication”, as used herein, refers to a communication between two or more computing devices (e.g., computer, personal digital assistant, cellular telephone, network device) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

“Computer-readable medium,” as used herein, refers to a non-transitory medium that stores instructions and/or data. A computer-readable medium can take forms, including, but not limited to, non-volatile media, and volatile media. Non-volatile media can include, for example, optical disks, magnetic disks, and so on. Volatile media can include, for example, semiconductor memories, dynamic memory, and so on. Common forms of a computer-readable medium can include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Database,” as used herein, is used to refer to a table. In other examples, “database” can be used to refer to a set of tables. In still other examples, “database” can refer to a set of data stores and methods for accessing and/or manipulating those data stores. A database can be stored, for example, at a disk and/or a memory.

“Disk,” as used herein can be, for example, a magnetic disk drive, a solid-state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry can include and/or be a part of a processor controlled by an algorithm, a discrete logic (e.g., ASIC), an analog circuit, a digital circuit, a programmed logic device, a memory device containing instructions, and so on. Logic can include one or more gates, combinations of gates, or other circuit components. Where multiple logics are described, it can be possible to incorporate the multiple logics into one physical logic. Similarly, where a single logic is described, it can be possible to distribute that single logic between multiple physical logics.

“Memory,” as used herein can include volatile memory and/or nonvolatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory can store an operating system that controls or allocates resources of a computing device.

“Operable connection,” or a connection by which entities are “operably connected,” is one in which signals, physical communications, and/or logical communications can be sent and/or received. An operable connection can include a wireless interface, a physical interface, a data interface, and/or an electrical interface.

“Module”, as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module can also include logic, a software controlled microprocessor, a discrete logic circuit, an analog circuit, a digital circuit, a programmed logic device, a memory device containing executing instructions, logic gates, a combination of gates, and/or other circuit components. Multiple modules can be combined into one module and single modules can be distributed among multiple modules.

“Portable device”, as used herein, is a computing device typically having a display screen with user input (e.g., touch, keyboard) and a processor for computing. Portable devices include, but are not limited to, handheld devices, mobile devices, smart phones, laptops, tablets and e-readers.

“Processor,” as used herein, processes signals and performs general computing and arithmetic functions. Signals processed by the processor can include digital signals, data signals, computer instructions, processor instructions, messages, a bit, a bit stream, that can be received, transmitted and/or detected. Generally, the processor can be a variety of various processors including multiple single and multicore processors and co-processors and other multiple single and multicore processor and co-processor architectures. The processor can include logic circuitry to execute actions and/or algorithms.

“Vehicle,” as used herein, refers to any moving vehicle that is capable of carrying one or more human occupants and is powered by any form of energy. The term “vehicle” includes, but is not limited to cars, trucks, vans, minivans, SUVs, motorcycles, scooters, boats, go-karts, amusement ride cars, rail transport, personal watercraft, and aircraft. In some cases, a motor vehicle includes one or more engines. Further, the term “vehicle” can refer to an electric vehicle (EV) that is capable of carrying one or more human occupants and is powered entirely or partially by one or more electric motors powered by an electric battery. The EV can include battery electric vehicles (BEV) and plug-in hybrid electric vehicles (PHEV). The term “vehicle” can also refer to an autonomous vehicle and/or self-driving vehicle powered by any form of energy. The autonomous vehicle can carry one or more human occupants. Further, the term “vehicle” can include vehicles that are automated or non-automated with pre-determined paths or free-moving vehicles.

“Vehicle display”, as used herein can include, but is not limited to, LED display panels, LCD display panels, CRT display, plasma display panels, touch screen displays, among others, that are often found in vehicles to display information about the vehicle. The display can receive input (e.g., touch input, keyboard input, input from various other input devices, etc.) from a user. The display can be located in various locations of the vehicle, for example, on the dashboard or center console. In some embodiments, the display is part of a portable device (e.g., in possession or associated with a vehicle occupant), a navigation system, an infotainment system, among others.

“Vehicle control system” and/or “vehicle system,” as used herein can include, but is not limited to, any automatic or manual systems that can be used to enhance the vehicle, driving, and/or safety. Exemplary vehicle systems include, but are not limited to: an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, an interior or exterior camera system among others.

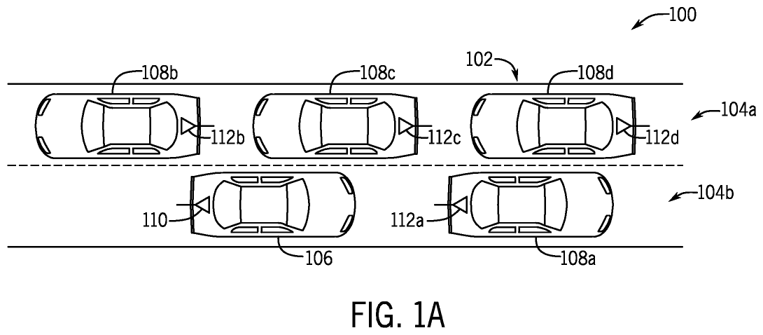

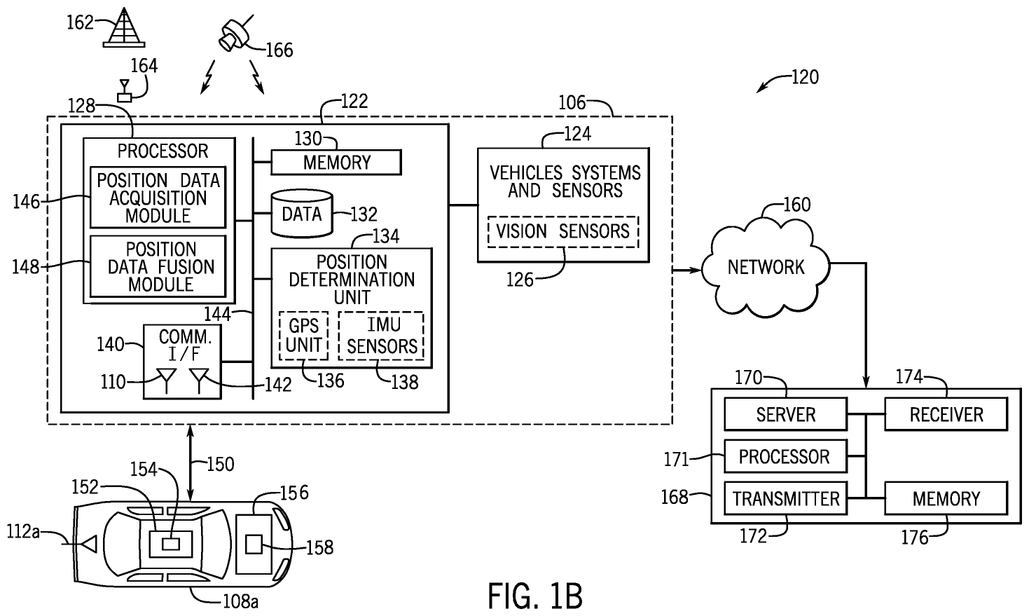

The systems and methods described herein are generally directed to vehicle path estimation using a vehicle communication network. FIG. 1A illustrates an exemplary traffic scenario 100 implementing path estimation using an exemplary vehicle communication network that will be used to describe some of the exemplary systems and exemplary methods herein. The traffic scenario 100 involves one or more vehicles on a roadway 102. The roadway 102 has a first lane 104a and a second lane 104b. It is understood that the roadway 102 can have various configurations not shown in FIG. 1A, and can have any number of lanes.

In FIG. 1A, the traffic scenario 100 includes a first vehicle 106, a second vehicle 108a, a third vehicle 108b, a fourth vehicle 108c, and a fifth vehicle 108d. In some embodiments, the first vehicle 106, the second vehicle 108a, the third vehicle 108b, the fourth vehicle 108c, and the fifth vehicle 108d can be referred to as remote vehicles 108 or a plurality of remote vehicles 108. In other embodiments, the first vehicle 106 can be referred to as a host vehicle, and the second vehicle 108a, the third vehicle 108b, the fourth vehicle 108c, and the fifth vehicle 108d can be referred to as remote vehicles 108 or a plurality of remote vehicles 108. The path estimation and localization examples discussed herein, are directed to determining a path of the first vehicle 106, and the data used for the path estimation can be derived from the first vehicle 106 and the plurality of remote vehicles 108 using a vehicle communication network. However, it is understood, that the path estimation and localization discussed herein can be applied to any of the vehicles shown in FIG. 1A.

The first vehicle 106 and the remote vehicles 108 can also include or be referred to as vehicle-to-vehicle (V2V), vehicle-to-infrastructure (V2I), or vehicle-to-everything (V2X) devices. In some embodiments, the V2X devices also include portable devices (e.g., associated with pedestrians), traffic lights, parking meters, among other roadside devices (e.g., RSE 164, FIG. 1B) that are operably connected for computer communication with the vehicle communication network. Further, it is understood that the systems and methods discussed herein can be implemented with more than five vehicles and/or V2I or V2X devices or less than five vehicles and/or V2I or V2X devices. Also, it is understood that the first vehicle 106 and the remote vehicles 108 can be in different configurations and positions other than those shown in FIG. 1A.

The first vehicle 106 and the remote vehicles 108 can communicate as part of a vehicle communication network, which will be discussed in more detail herein with FIG. 1B. The vehicle communication described herein can be implemented using Dedicated Short Range Communications (DSRC). However, it is understood that the vehicle communication described herein can be implemented with any communication or network protocol, for example, ad hoc networks, wireless access within the vehicle, cellular networks (e.g., 4G, LTE, 5G, etc.), Wi-Fi networks (e.g., IEEE 802.11), Bluetooth, WAVE, CALM, Ultra-Wideband, or any other form of wireless communication. Further, as mentioned above, the vehicle communication network can support vehicle-to-vehicle (V2V), vehicle-to-infrastructure (V2I), and/or vehicle-to-everything (V2X) communication networks and entities.

In FIG. 1A, the first vehicle 106 can transmit, receive, and/or exchange communications including data, messages, images, and/or other information with other vehicles, user, or infrastructures, using DSRC, or any other short, medium or long range communication protocol described above. In particular, the first vehicle 106 is equipped with a vehicle-to-vehicle (V2V) transceiver 110 that can exchange messages and information with other vehicles, users, or infrastructures that are operable for computer communication with the first vehicle 106. For example, the V2V transceiver 110 can communicate with the second vehicle 108a via a V2V transceiver 112a, the third vehicle 108b via a V2V transceiver 112b, the fourth vehicle 108c via a V2V transceiver 112d, and/or the fifth vehicle 108d via a V2V transceiver 112d. The remote vehicles 108 can similarly communicate with one another using their respective transceivers.

In FIG. 1A, the first vehicle 106 and the remote vehicles 108 can “see” or observe one another, other entities along the roadway 102, road landmarks, among others, utilizing respective sensors, which will be discussed in further detail herein with FIG. 1B. Localization and path estimation can be implemented and refined using sensor data from different sources and exchanging this data using the vehicle communication network. Referring now to FIG. 1B, a vehicle communication network 120 for implementing vehicle path estimation according to an exemplary embodiment will be discussed in detail with further reference to FIG. 1A. The components of the first vehicle 106 and the vehicle communication network 120, as well as the components of other systems, hardware architectures, and software architectures discussed herein, can be combined, omitted, or organized into different architectures for various embodiments. In FIG. 1B, the first vehicle 106 includes a vehicle computing device (VCD) 122, and one or more vehicle systems and sensors 124, which can include vision sensors 126.

Generally, the VCD 122 includes a processor 128, a memory 130, a data store 132, a position determination unit 134, and a communication interface 140, which are each operably connected for computer communication via a bus 144 and/or other wired and wireless technologies. Some of the components shown in FIG. 1B with respect to the first vehicle 106 are not shown with respect the second vehicle 108a. For simplicity, in FIG. 1B, the second vehicle 108a includes a processor 152, a position determination unit 154, vehicle systems and sensors 156, and vision sensors 158, which can include the same components and functionality discussed in detail with the first vehicle 106. It is understood that although not shown in FIG. 1B, one or more of the components of the first vehicle 106, can also be implemented with the second vehicle 108a, the other remote vehicles 108, entities, and devices (e.g., V2X devices) operable with the vehicle communication network 120.

Referring again to the first vehicle 106, the VCD 122, can include provisions for processing, communicating and interacting with various components of the first vehicle 106 and other components of the vehicle communication network 120, including the second vehicle 108a. In one embodiment, the VCD 122 can be implemented with the first vehicle 106, for example, as part of a telematics unit, a head unit, an infotainment unit, an electronic control unit, an on-board unit, or as part of a specific vehicle control system, among others. In other embodiments, the VCD 122 can be implemented remotely from the first vehicle 106, for example, with a portable device (not shown), a remote device (not shown), a remote server (e.g., remote server 170), or a remote processor (e.g., remote processor 171) connected via the vehicle communication network 120.

The processor 128 can include logic circuitry with hardware, firmware, and software architecture frameworks for facilitating vehicle path estimation with the components of the VCD 122 and the vehicle communication network 120. Thus, in some embodiments, the processor 128 can store application frameworks, kernels, libraries, drivers, application program interfaces, among others, to execute and control hardware and functions discussed herein. For example, in FIG. 1B, the processor 128 can include a position data acquisition module 146 and a position data fusion module 148. In some embodiments, the memory 130 and/or the data store (e.g., disk) 132 can store similar components as the processor 128 for execution by the processor 128.

The position determination unit 134 can include hardware (e.g., sensors) and software to determine and/or acquire position data about the first vehicle 106. For example, the position determination unit 134 can include a global positioning system (GPS) unit 136 and/or an inertial measurement unit (IMU) 138 (e.g., on-board motion and position sensors). The GPS unit 136 can provide a geoposition of the first vehicle 106 based on satellite data from the global position source 166. The IMU unit 138 can include a gyroscope, accelerometer, magnetometers, among other sensors. Thus, the IMU unit 138 can provide dead-reckoning data or motion data about the first vehicle 106. In some embodiments, the position determination unit 134 can be a navigation system that provides navigation maps and navigation information to the first vehicle 106. Thus, the position determination unit 134 can be any type of known, related or later developed navigational system. The phrase “navigation information” refers to any information that can be used to assist the first vehicle 106 in navigating a roadway or path. Navigation information may include traffic data, map data, and roadway classification information data. Navigation information can also include geographical information, including information obtained from any Global Navigational Satellite infrastructure (GNSS), including Global Positioning System or Satellite (GPS), Glonass (Russian) and/or Galileo (European).

The communication interface 140 can include software and hardware to facilitate data input and output between the components of the VCD 122 and other components of the vehicle communication network 120. Specifically, the communication interface 140 can include network interface controllers (not shown) and other hardware and software that manages and/or monitors connections and controls bi-directional data transfer between the communication interface 140 and other components of the vehicle communication network 120. More specifically, and as mentioned with FIG. 1A above, the VCD 122 can exchange vehicle data, including messages and position measurements (e.g., from the vision sensors 126 and/or the position determination unit 134), with other DSRC compatible vehicles and devices via the V2V transceiver 110. For example, in FIG. 1B, the V2V transceiver 110 can exchange data with the second vehicle 108a via the V2V transceiver 112a using a communication link 150.

Although only two vehicles are shown in FIG. 1B, it is understood that the first vehicle 106 can communicate with more than one vehicle, device and/or entity configured for communication (e.g., DSRC) with the vehicle communication network 120, for example the remote vehicles 108 shown in FIG. 1A. Thus, is some embodiments, communication links can be established between the first vehicle 106 and a plurality of other vehicles (e.g., plurality of remote vehicles 108) configured for communication using the vehicle communication network 120. Further, in some embodiments, the first vehicle 106 and the second vehicle 108a can exchange data utilizing a wireless network antenna 162, roadside equipment (RSE) 164, and/or a communication network 160, which can be a wireless communication network, or other wireless network connections.

As will be discussed herein, various types of data can be communicated using the vehicle communication network 120. In some embodiments, data is communicated via DSRC by exchanging one or more basic safety messages (BSM). The BSM that is broadcast by a vehicle can contain a number of data elements that describe various aspects of the operation of the vehicle or provide information about the vehicle itself. For example, the type and/or specifications of the vehicle, navigation data, roadway hazard data, traffic location data, course heading data, course history data, projected course data, kinematic data, current vehicle position data, range or distance data, speed and acceleration data, location data, vehicle sensory data, vehicle subsystem data, and/or any other vehicle information between networked vehicles for use in vehicle driving. In the embodiments discussed herein, position measurements, including geoposition measurements based on satellite data, dead-reckoning measurement based on on-board sensor data, and vision measurements based on vision data and/or radar data can be communicated between the first vehicle 106 and the remote vehicles 108 using the vehicle communication network 120.

As mentioned above, in some embodiments, vehicle path estimation and data transmission can be executed at and/or with other infrastructures and servers. For example, in FIG. 1B, the VCD 122 can transmit and receive information directly or indirectly to and from a service provider 168 over the communication network 160. The service provider 168 can include a remote server 170, a processor 171, a remote transmitter 172, a remote receiver 174, and a remote memory 176 that are configured to be in communication with one another.

In FIG. 1B, the V2V transceiver 110 can be used by the VCD 122 to receive and transmit information to and from the service provider 168 and other servers, processors, and information providers through the communication network 160. In alternative embodiments, a radio frequency (RF) transceiver 142 in the first vehicle 106 can be used to receive and transmit information to and from the service provider 168. In some embodiments, the VCD 122 can receive and transmit information to and from the service provider 168 including, but not limited to, traffic data, vehicle location and heading data, high-traffic event schedules, weather data, or other transport related data. In some embodiments, the service provider 168 can be linked to multiple vehicles (e.g., the second vehicle 108a), other entities and/or devices through a network connection, such as via the wireless network antenna 162, and/or other network connections.

Using the network configuration discussed above, the first vehicle 106 and the second vehicle 108a can communicate data for vehicle path estimation and localization. More specifically, position measurements derived from GPS data (e.g., from the global position source 166), dead-reckoning data (e.g., from the IMU unit 138), and vision data (e.g., from the vision sensors 126) can be communicated between the first vehicle 106 and the second vehicle 108a for vehicle path estimation using the vehicle communication network 120. The vehicle systems and sensors 124 can include various types of sensors for use with the first vehicle 106 and/or the vehicle systems for detecting and/or sensing a parameter of that system.

The vision sensors 126 (e.g., imaging devices, cameras) can capture image or video data, and in some embodiments, can be part of a computer vision system. In other embodiments, the vision sensors 126 can include ranging sensors (e.g., LIDAR, RADAR) for capturing distance or speed information. As discussed herein, the vision sensors 126 can provide vision data and/or vision position measurements (e.g., vision data, image data, ranging data). It is understood that the vision sensors 126 can be disposed in one or more portions of the first vehicle 106. For example, although not shown in FIG. 1B, the vision sensors 126 could be integrated into a dashboard, seat, seat belt, door, bumper, front, rear, corners, dashboard, steering wheel, center console, rearview mirror, roof or any other portion of the first vehicle 106. In other cases, however, the vision sensors 126 could be portable sensors worn by a driver (not shown), integrated into a portable device (not shown), carried by the driver (not shown), integrated into an article of clothing (not shown) worn by the driver, or integrated into the body of the driver (e.g. an implant) (not shown).

In some of the examples discussed herein, the vision sensors 126 will be described as a vision sensor unit that includes one or more cameras that may be mounted on the first vehicle 106, for example, mounted on a windshield, a front dashboard, a grill, a rear-view mirror, among others. In other embodiments discussed herein, the vision sensors 126 can include ranging sensors. For example, a front long range RADAR and/or a front mid-range RADAR. The front long range RADAR can measure distance (e.g., lateral, longitudinal) and speed of objects surrounding the first vehicle 106. For example, the first long range RADAR can measure distance and speed of other vehicles (e.g., the second vehicle 108a) and/or other objects and entities surrounding the first vehicle 106. In other embodiments, the vision sensors 126 can include a plurality of RADARs in different location of the first vehicle 106. For example, a front left RADAR located at a front left corner area of the first vehicle 106, a front right RADAR located at a front right corner area of the first vehicle 106, a rear left RADAR located at a rear left corner area of the first vehicle 106, and a rear right RADAR located at a rear right corner area of the first vehicle 106. Although the vision sensors discussed above are with respect to the first vehicle 106, the same or similar functions can be implemented with the other remote vehicles 108, for example the vision sensors 158.

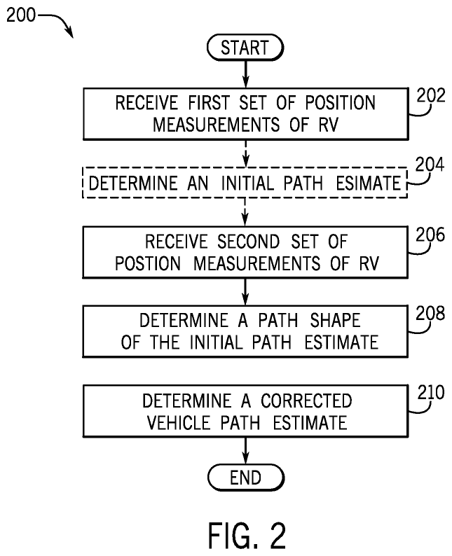

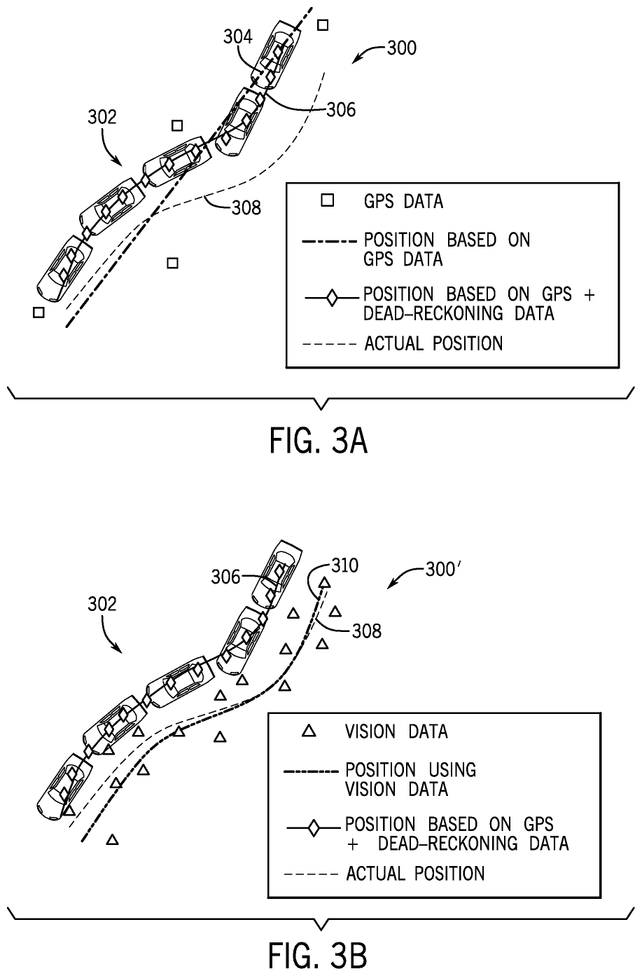

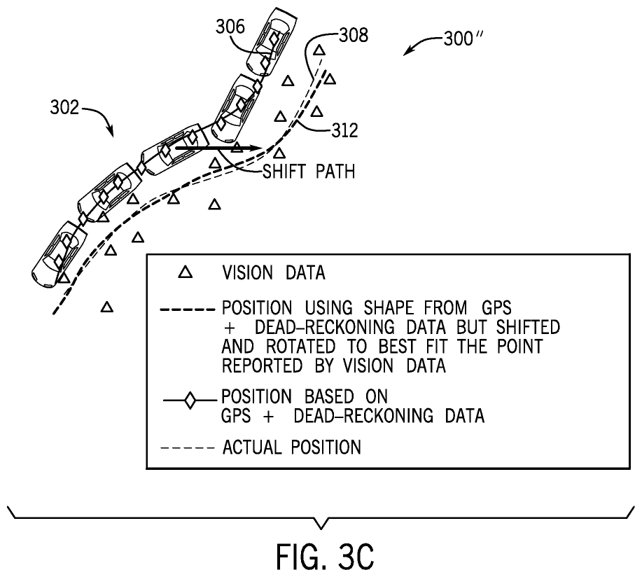

In the embodiments discussed herein, tightly coupled V2X position measurements based on satellite data from the GPS unit 136 and dead-reckoning data from the IMU sensors 138 are combined with vision data from the vision sensors 126 to provide vehicle path estimation and localization. In particular, these position measurements are communicated between the remote vehicles 108 using the vehicle communication network 120 to determine and refine the vehicle path estimation and localization. Such exemplary systems and methods for vehicle path estimation using the vehicle communication network 120 discussed above will now be described in more detail. Referring now to FIG. 2, a method 200 for vehicle path estimation using the vehicle communication network 120 will be discussed with further reference to FIGS. 1A and 1B. Additionally, the method 200 will be described with reference to the illustrative examples shown in FIGS. 3A, 3B, and 3C. The exemplary methods discussed herein are described with respect to the processor 128 of the first vehicle 106. However, it is understood that the processor 152 of the second vehicle 108a, the processor 171 of the remote service provider 168, and/or a processor of any of the remote vehicles 108 can perform the same or similar functions.

The method 200 includes, at block 202, receiving a first set of position measurements of a remote vehicle from messages transmitted using the vehicular communication network. Thus, the processor 128 can receive the first set of position measurements, which relate to a position and a path of the of the first vehicle 106, from the remote vehicles 108 using the vehicle communication network 120. For example, as discussed herein, remote vehicles 108, devices, and other entities operable for communication using the vehicle communication network 120 can periodically transmit (e.g., broadcast) messages including position data to other remote vehicles 108. Thus, in one embodiment, the processor 128 receives the first set of position measurements from messages transmitted by the remote vehicles 108 using the vehicle communication network 120.

In one embodiment, the first set of position measurements about the first vehicle 106 can be derived from satellite data, from, for example, the global position source 166. Thus, the first vehicle 106 can receive its geoposition from the global position source 166 via the GPS unit 136, and the first vehicle 106 can receive observed gepositions about the first vehicle 106 from the remote vehicles 108, where the remote vehicles 108 determine the observed gepositions about the first vehicle 106 from satellite data from the global position source 166. In addition, the first vehicle 106 can also receive the geoposition of each remote vehicle 108 as determined by the transmitting remote vehicle 108. As an example, GPS data indicating the observed geoposition of the first vehicle 106 can be determined by a position determination unit 154 and transmitted to the processor 128. Said differently, the processor 128 can receive a geoposition from each of the remote vehicles 108 surrounding the first vehicle 106 and determine its own geoposition from the GPS unit 136.

Referring now to FIG. 3A, a schematic diagram 300 of exemplary position measurements and initial path estimation using GPS and dead-reckoning data according to an exemplary embodiment is shown. The diagram 300 illustrates a path 302 of the first vehicle 106. The squares surrounding the path 302 indicate GPS position measurements derived from satellite data, as discussed above with block 202. Based on the GPS position measurements, the processor 128 can determine a path 304, which is an estimated path of the first vehicle 106 based on the GPS position measurements. As will be discussed herein, the path 304 based only on GPS position measurements exhibits low precision and low accuracy with respect to an actual path 308 of the first vehicle 106.

Referring again to block 202, in one embodiment, the first set of position measurements are also derived from on-board sensor data, for example, from the IMU sensors 138. In some embodiments, the on-board sensor data is referred to as dead-reckoning data or motion data from gyroscope, accelerometer, and magnetometer sensors, among others. The processor 128 can determine its own position measurements based on the dead-reckoning data from the IMU sensors 138, and receive observed position measurements based on dead-reckoning data transmitted by the remote vehicles 108. For example, the second vehicle 108a can determine observed position measurements based on dead-reckoning data from the position determination unit 154 and transmit the observed position measurements to the first vehicle 106.

Accordingly, in one embodiment, at block 204, using data fusion, an initial path estimate 306 of the first vehicle 106 can be determined using the GPS data and the dead-reckoning data. As shown in FIG. 3A, the initial path estimate 306 is based on GPS data and dead-reckoning data, which can be fused, smoothed, and/or averaged using known filtering techniques. The initial path estimate 306 exhibits low precisions and high accuracy with respect to the actual path 308 of the first vehicle 106.

Additionally, in some embodiments, the first set of position measurements can also include path history measurements of the first vehicle 106. For example, each remote vehicle 108 operable for communication using the vehicle communication network 120 can periodically transmit a list of path history points that allows the surrounding remote vehicles 108 to reconstruct the path history of the remote vehicle 108. Accordingly, in some embodiments, the initial path estimate 306 can also be determined using the path history points of the first vehicle 106 and the observed path history points of the first vehicle 106 from the remote vehicles 108.

At block 206, the method 200 includes, receiving a second set of position measurements of the first vehicle 106 from messages transmitted using the vehicular communication network. Thus, the processor 128 can receive the second set of position measurements, which relate to a position and a path of the of the first vehicle 106, from the remote vehicles 108 using the vehicle communication network 120. In one embodiment, second set of position measurements are vision position measurements derived from vision data (e.g., images) captured by the first vehicle 106 (e.g., by the vision sensors 126) and/or the remote vehicles 108 (e.g., by the vision sensors 158). In other embodiments, the second set of position measurements are can be range position measurements based on range data captured by ranging sensors (e.g., RADAR, LIDAR) of the first vehicle 106 and/or the remote vehicles 108. As an illustrative example, the vision position measurements can be the positions of observable landmarks along the roadway 102 surrounding the first vehicle 106. The vision position measurements received from the remote vehicles 108 can also be observable vision position measurements from the perception of the remote vehicles 108. For example, the vision position measurements can be positions of observable landmarks surrounding the first vehicle 106 as determined by images captured by the vision sensors 158 of the second vehicle 108a.

Referring now to FIG. 3B, a schematic diagram 300′ illustrates the initial path estimate 306 of FIG. 3A, but with exemplary positions measurements based on vision data. The triangles surrounding the path 302 indicate vision data received from the first vehicle 106 and the remote vehicles 108. A vision path estimate 310 is determined based on the vision data. The vision path estimate 310 based on the vision data exhibits high precision and high accuracy with respect to the actual path 308 of the first vehicle 106.

At block 208, the method 200 includes, determining a path shape of an initial path estimate of the first vehicle 106. As discussed above with blocks 202 and 204, the initial path estimate 306 is based on the first set of position measurements, specifically, GPS data and dead-reckoning data. Since the initial path estimate 306 includes the dead-reckoning data, the motion profile of the first vehicle 106 is preserved. Accordingly, the processor 128 determines the path shape of the initial path estimate 306 as a description of the initial path estimate 306 as a sequence of relative movements. Said differently, the path shape is a sequence of relative movements based on the first set of position measurements.

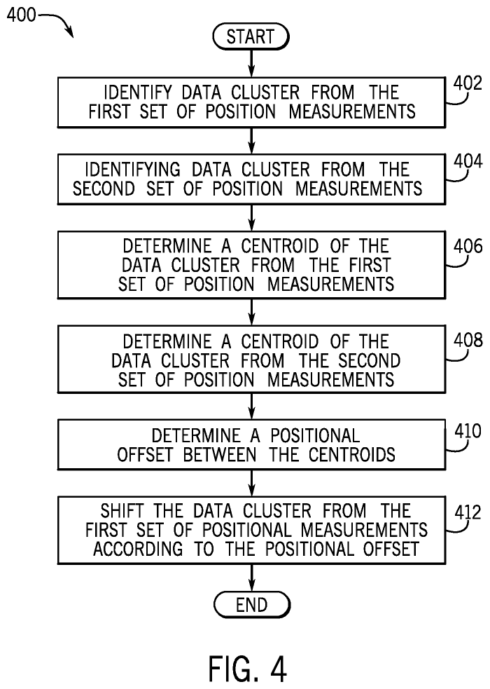

At block 210, the method 200 includes determining a corrected vehicle path estimate of the first vehicle 106 by fitting the second set of position measurements to the path shape of the initial path estimate. Thus, in one embodiment, the processor 128 determines a corrected vehicle path estimate of the first vehicle 106 by translating the path shape of the initial path estimate 306 to minimize a distance between the first set of position measurements and the second set of position measurements. FIG. 3C shows the schematic diagram 300″ with the initial path estimate 306 of FIG. 3A shifted to a corrected vehicle path estimate 312 by fitting the shape of the initial path estimate 306 to the vision position measurements. More details on determining the corrected vehicle path estimate will be discussed in more detail herein with FIG. 4.

The corrected vehicle path estimate determined at block 210 can be used by the first vehicle 106 for any localization and positioning functions. The corrected vehicle path estimate 312 provides refined positioning of the vehicle itself and of objects around the vehicle as a result of having a more accurate position. For example, the corrected vehicle path estimate 312 can be used by the position determination unit 134 for localization and navigation control. In some embodiments, the corrected vehicle path estimate 312 can be used for high-definition mapping for navigation control and autonomous vehicle path planning and driving control. In other embodiments, the corrected vehicle path estimate 312 can be used by any of the vehicle systems and sensors 124. For example, advanced driver assistance systems (e.g., lane keep assist, collision mitigation, adaptive cruise control) can utilized the corrected vehicle path estimate 312 for lane detection, localization, and positioning, among others. As a further example, using V2V communication, the corrected vehicle path estimate 312 can be provided for path history estimation. Thus, the corrected vehicle path estimate 312 can be transmitted to the remote vehicles 108 using the vehicle communication network 120. It is understood that the corrected vehicle path estimate 312 can be used for any other type of position determination, localization, or vehicle control not discussed herein.

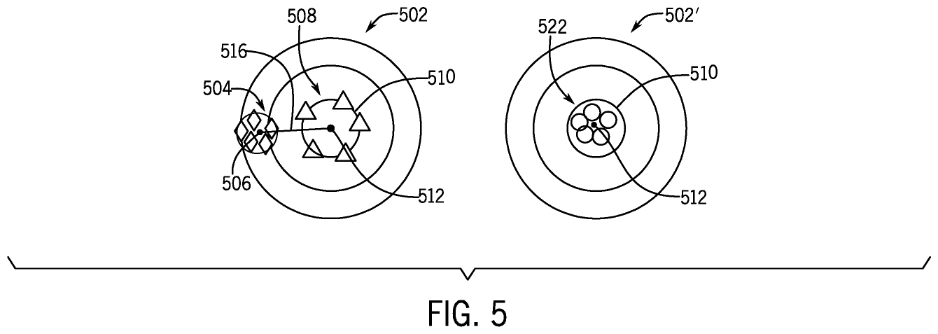

Determining the corrected vehicle path estimate 312 will now be discussed in more detail with respect to the method 400 of FIG. 4 and the illustrative examples shown in FIG. 5. As mentioned above with block 210, the path shape of the initial path estimate 306 based on GPS data and dead-reckoning data is shifted and/or fitted to the vision data. Thus, in some embodiments, data clusters of the GPS data and the dead-reckoning data are shifted according to a center generated by a cluster of the vision data. Referring now to FIG. 4, at block 402, the method 400 includes identifying a data cluster and/or a plurality of data clusters based on the first set of position measurements. As mentioned above with block 202, the first set of position measurements can include GPS data and dead-reckoning data which is shown by the estimated path 306 including the diamond shaped data points that represent the fused GPS data and dead-reckoning data. In FIG. 5, a data diagram 502 illustrates five (5) GPS and dead-reckoning data points represented by diamond shapes. These five data points represent the fused GPS data and dead-reckoning data provided by each vehicle, namely, the first vehicle 106 and the remote vehicles 108. The processor 128 can identify a data cluster 504 based on the first set of position measurements. The data cluster can be identified using known statistical data cluster analysis methods.

Similarly, at block 404, the method 400 includes, identifying a data cluster and/or a plurality of data clusters from the second set of position measurements. As mentioned above with block 204, the second set of position measurements can include vision data. In FIG. 5, the data diagram 502 also illustrates five (5) vision data points represented by triangle shapes. These dive data points represent the vision data provided by each vehicle, namely, the first vehicle 106 and the remote vehicles 108. As an illustrative example, the vision data points can represent a position measurement of a landmark surrounding the first vehicle 106 as observed from each of the first vehicle 106 and the remote vehicles 108. The processor 128 can identify a data cluster 508 based on the second set of position measurements. The data cluster can be identified using known statistical data cluster analysis methods.

A block 406, the method 400 includes, determining a centroid of the data cluster based on the first set of positional measurements. For example, a centroid 506 is determined for the data cluster 504. A centroid for a data cluster and/or a plurality of data points can be determined using the mean value of the points in the cluster. In other embodiments, the median can be used instead of the mean value. Similarly, at block 408, the method 400 includes, determining a centroid of the data cluster and/or a centroid of each data cluster in the plurality of data clusters based on the second set of position measurements. For example, the processor 128 can determine a centroid 512 for the data cluster 508. Also, as shown in diagram 502, a center 510 has been generated as defined by the second set of position measurements, the data cluster 508 and the centroid 512. As will be discussed herein, the first set of position measurements are shifted to fit according to the center 510.

At block 410, the method 400 includes, determining a positional offset between the centroids. In FIG. 5, an offset 516 (or a distance) between the centroid 513 and the centroid 506 is determined. An offset can include x, y, and z, coordinates in which to shift the first set of position measurements and/or the data cluster 504 so that these data points fit within the center 510. At block 412, the method 400 includes, shifting the data cluster from the first set of positional measurements according to the positional offset. The circles in diagram 502′ represent the fused data, namely, the first set of position measurements and the second set of position measurements. Thus, to determine the corrected vehicle path estimate 312 of the first vehicle 106, the initial path estimate 306 is shifted using the centroid of each data cluster. For example, the processor 128 positions the path shape of the initial path estimate 306 according to the centroid of each data cluster, thereby minimizing x, y, and z, position between the initial path estimate 306 and the vision path estimate 310. The processor 128 determines a corrected vehicle path estimate of the first vehicle 106 by adjusting the distance 516 between at least one data cluster 504 of the first set of position measurements and at least one data cluster 598 of the second set of position measurements.

The embodiments discussed herein can also be described and implemented in the context of computer-readable storage medium storing computer executable instructions. Computer-readable storage media includes computer storage media and communication media. For example, flash memory drives, digital versatile discs (DVDs), compact discs (CDs), floppy disks, and tape cassettes. Computer-readable storage media can include volatile and nonvolatile, removable and non-removable media implemented in any method or technology for storage of information such as computer readable instructions, data structures, modules or other data. Computer-readable storage media excludes non-transitory tangible media and propagated data signals.

It will be appreciated that various implementations of the above-disclosed and other features and functions, or alternatives or varieties thereof, can be desirably combined into many other different systems or applications. Also that various presently unforeseen or unanticipated alternatives, modifications, variations or improvements therein can be subsequently made by those skilled in the art which are also intended to be encompassed herein.

1. A computer-implemented method for vehicle path estimation using a vehicular communication network, comprising:
receiving a first set of position measurements related to a position of a first remote vehicle and a second set of position measurements related to the position of the first remote vehicle from messages transmitted using the vehicular communication network;
determining a path shape of an initial path estimate of the first remote vehicle, wherein the initial path estimate is based on the first set of position measurements; and
determining a corrected vehicle path estimate of the first remote vehicle by fitting the second set of position measurements to the path shape of the initial path estimate.

2. The computer-implemented method of claim 1, wherein the first set of position measurements are received from messages transmitted by one or more remote vehicle using the vehicular communication network and the first set of position measurements are derived from on-board sensor data.

3. The computer-implemented method of claim 2, wherein the first set of position measurements are derived from satellite data.

4. The computer-implemented method of claim 2, wherein the first set of position measurements includes path history measurements of the first remote vehicle.

5. The computer-implemented method of claim 1, wherein the second set of position measurements are received from messages transmitted by one or more remote vehicles using the vehicular communication network.

6. The computer-implemented method of claim 5, wherein the second set of position measurements are vision position measurements derived from images captured by the one or more remote vehicles.

7. The computer-implemented method of claim 6, wherein the second set of position measurements are vision position measurements derived from images captured by the first remote vehicle.

8. The computer-implemented method of claim 1, further including identifying data clusters from the second set of position measurements and determining a centroid of each data cluster.

9. The computer-implemented method of claim 8, wherein determining the corrected vehicle path estimate of the first remote vehicle includes shifting the initial path estimate using the centroid of each data cluster.

10. A system for vehicle path estimation using a vehicular communication network, comprising:
a plurality of remote vehicles configured for computer communication using the vehicular communication network; and
a processor operably connected for computer communication with the plurality of remote vehicles, wherein the processor is configured to:
receive a first set of position measurements about a first remote vehicle and a second set of position measurements about the first remote vehicle using the vehicular communication network;
determine a path shape of an initial path estimate of the first remote vehicle, wherein the initial path estimate is based on the first set of position measurements; and
determine a corrected vehicle path estimate of the first remote vehicle by fitting the second set of position measurements to the path shape of the initial path estimate.

11. The system of claim 10, wherein the first set of position measurements are derived from sensors of the plurality of remote vehicles and satellite data from a global positioning source.

12. The system of claim 10, wherein the second set of position measurements are derived from images captured by the plurality of remote vehicles and images captured by the first remote vehicle.

13. The system of claim 10, wherein the processor is configured to identify a plurality of data clusters based on the second set of position measurements and determine a centroid of each data cluster of the plurality of data clusters.

14. The system of claim 13, the processor determines the corrected vehicle path estimate of the first remote vehicle by positioning the path shape of the initial path estimate according to the centroid of each data cluster.

15. A non-transitory computer-readable storage medium including instructions that when executed by a processor, causes the processor to:
establish an operable connection for computer communication between a first remote vehicle and one remote vehicles using a vehicular communication network;
receive a first set of position measurements about a position of the first remote vehicle and a second set of position measurements about the position the first remote vehicle from messages transmitted using the vehicular communication network;
determine a path shape of an initial path estimate of the first remote vehicle, wherein the initial path estimate is based on the first set of position measurements; and
determine a corrected vehicle path estimate of the first remote vehicle by translating the path shape of the initial path estimate to minimize a distance between the first set of position measurements and the second set of position measurements.

16. The non-transitory computer-readable storage medium of claim 15, wherein the first set of position measurements are derived from sensor data captured by the one or more remote vehicles and geoposition data from a global satellite source.

17. The non-transitory computer-readable storage medium of claim 15, wherein the processor receives the second set of position measurements from messages transmitted by the one or more remote vehicles using the vehicular communication network.

18. The non-transitory computer-readable storage medium of claim 15, wherein the second set of position measurements are derived from images captured by the one or more remote vehicles.

19. The non-transitory computer-readable storage medium of claim 15, wherein the processor calculates the initial path estimate based on the first set of position measurements.

20. The non-transitory computer-readable storage medium of claim 15, wherein the processor determines a corrected vehicle path estimate of the first remote vehicle by adjusting a distance between at least one data cluster of the first set of position measurements and at least one data cluster of the second set of position measurements.
